(19) United States
(12) Patent Application Publication
(10) Pub. No.: US 2003/0063322 A1
(43) Pub. Date: Apr. 3, 2003

(54) Image taking apparatus

(76) Inventors: Ayumi Itoh, Ikoma-Gun (JP); Noriyuki Okisu, Osakasayama-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/255,508

(22) Filed: Sep. 26, 2002

(30) Foreign Application Priority Data
Oct. 1, 2001 (JP) 2001-304856
Oct. 1, 2001 (JP) 2001-304860
Oct. 1, 2001 (JP) 2001-304867

(51) Int. Cl. H04N 1/21; H04N 1/23

(52) U.S. Cl. 358/302; 358/296

(57) ABSTRACT

In an image taking apparatus in which a plurality of different types of image are previously defined to correspond to different sets of shooting conditions so that the type of an image to be taken is determined according to the shooting conditions under which the image is going to be taken, different types of image are discriminated more precisely than ever. After the type of the image is determined, the shooting conditions are still monitored so that, if a change is detected therein, the type of the image is re-determined. The type of the image is re-determined either when there has been even a slight change in the shooting conditions or when the shooting conditions have changed out of a predetermined range, and either when a change in the shooting conditions has persisted for a predetermined period of time or when the shooting conditions have become stable after a change therein.

This application is based on Japanese Patent Applications Nos. 2001-304856, 2001-304860, and 2001-304867, all filed on Oct. 1, 2001, the contents of which are hereby incorporated by reference.

### BACKGROUND OF THE INVENTION

1. Field of the Invention

The present invention relates to an image taking apparatus in which a plurality of different types of image are previously defined to correspond to different sets of shooting conditions such as the state of the subject, the focal length of the taking lens, and other factors so that the type of an image to be taken is determined according to the shooting conditions under which the image is going to be taken.

2. Description of the Prior Art

There are commercially available such cameras as permit different shooting scenes to be classified into a plurality of types of scene, with each type assigned a different set of shooting conditions for variable parameters such as the shutter speed and the f-number of the taking lens, so that shooting is performed under conditions set according to the type of scene specified by the user. For example, between in a scene with a subject at rest and in a scene with a subject playing a sport, different combinations of the shutter speed and the f-number are used so that a faster shutter speed is selected in the sports scene. In any type of scene, images are obtained with appropriate exposure; by specifying the sports scene, however, a faster shutter speed is selected to reduce blurring of the subject in the obtained image. In this way, permitting the user to specify the type of scene so that shooting conditions are set according to the specified type of scene makes it easier for the user to obtain the intended image.

In recent years, there have been developed even such cameras as discriminate different shooting scenes by themselves (for example, U.S. Pat. No. 5,915,133). Many cameras have an automatic focusing (AF) capability that permits the taking lens to be automatically focused on the subject, and this capability can be exploited to detect the movement of the subject and thereby discriminate between a scene with a subject at rest and a scene with a subject playing a sport.

Moreover, in a scene with a subject at rest, it is possible to further discriminate, on the basis of the relationship between the distance to the subject and the focal length of the taking lens, a situation in which the user intends to take a snapshot with both the subject and the background sharply focused and a situation in which the user intends to take a portrait with the background out of focus. Cameras capable of such discrimination have also been proposed. In this case, different scenes, i.e., different conditions of the subject to be shot, are discriminated on the basis of the settings made in the camera, and therefore, strictly speaking, discrimination among different types of image is achieved by classifying an image to be shot, on the basis of the shooting conditions under which it is going to be taken, into one of a plurality of types that have previously been defined to correspond to different sets of shooting conditions. In practical terms, however, discriminating different types of images is mostly equivalent to discriminating different scenes, and therefore scene discrimination is understood to include image type discrimination.

Incidentally, the shooting conditions used to discriminate different types of image are different from those set according to the result of discrimination. The former are those set by the user. For example, the shooting conditions used for image type discrimination include the focal length of the taking lens, and the shooting conditions set according to the discrimination result include the shutter speed.

In general, in a camera, image type discrimination is performed at the end of automatic focusing. The result of discrimination is indicated on a display portion provided in the camera to permit the user to confirm the type of image determined by the camera. In this way, enabling a camera to discriminate different types of image by itself makes it still easier for the user to obtain the intended image. Even without particular intention, the user can obtain images rendered appropriately according to what appears in them, such as portraits with the background softly focused, sports cuts without blurring, etc.

In conventional cameras, however, image type discrimination is performed only once; that is, once the type of image is determined, image type discrimination is not performed again until, for example, automatic focusing is restarted on request. This means that, once the type of image is determined, even if shooting conditions such as the focal length of the taking lens change thereafter, shooting is controlled according to the type of image already determined. This occasionally results in inconsistency between the type of image actually shot and the type of image determined, producing inappropriately rendered images.

This is avoided, according to U.S. Pat. No. 5,915,133 mentioned above, by designing a camera to operate selectively either in a mode in which the camera determines the type of image by itself or a mode in which the user specifies it.

With this camera, however, switching the modes and specifying the type of image requires the user to go through a plurality of stages of operation such as key operation. This spoils the user-friendliness of the camera. In particular, when the type of image determined by the camera is indeed consistent with the user's intention but it undesirably changes as shooting conditions change thereafter, the user obtains a useful discrimination result in vain without ever exploiting it effectively. On the other hand, if the user frequently feels urged to manually specify the type of image, there is little sense in the camera having the capability for image type discrimination.

There are two types of automatic focusing, namely, focus-lock AF in which focusing is stopped as soon as the taking lens is focused on the subject, and continuous AF in which focusing is continued even after the taking lens is focused on the subject. While focus-lock AF is suitable for the shooting of a subject at rest, continuous AF is suitable for the shooting of a subject in motion. Many cameras permit the user to choose between focus-lock and continuous AF.

The mode of operation in which the user specifies the type of image and the mode of operation in which the camera determines it by itself can each be combined with either focus-lock or continuous AF. With focus-lock AF, which is adopted chiefly when a subject to be shot is at rest, once the taking lens is focused on the subject, the focus remains there. Thus, the type of image determined at the end of focusing is held until the time of shooting, making it possible to control shooting appropriately according to the discrimination result obtained at the end of focusing. If the user is not satisfied with the discrimination result offered by the camera, he or she can expressly specify the intended type of image so that the intended image is obtained without fail.

On the other hand, with continuous AF, which is adopted chiefly when a subject to be shot is in motion, even after the taking lens is focused on the subject, the focus continues to change. Thus, the result of image type recognition obtained at a given moment is not always appropriate at the time of shooting. Even if the user is not satisfied with the discrimination result offered by the camera and expressly specifies the intended type of image, the focus of the taking lens continues to change, making it impossible to obtain the intended image. Thus, there is no sense in the user expressly specifying the type of image.

### SUMMARY OF THE INVENTION

An object of the present invention is to provide an image taking apparatus that determines the type of an image to be taken according to the shooting conditions under which it is going to be taken, and that thereby copes with changes in shooting conditions appropriately to produce optimum images.

To achieve the above object, according to one aspect of the present invention, an image taking apparatus in which a plurality of different types of image are previously defined to correspond to different shooting conditions so that the type of an image to be taken is determined according to the shooting condition under which the image is going to be taken is provided with: a detecting element for detecting the shooting condition; a discriminating element for determining the type of the image according to the shooting condition detected by the detecting element; and a discrimination controlling element for detecting, after the discriminating element has determined the type of the image, a change in the shooting condition detected by the detecting element in order to make the discriminating element determine the type of image again.

In this image shooting apparatus, even after the type of an image is determined, when the shooting condition changes, the type of the image can be re-determined. This makes it possible to cope flexibly with the change of the type of the image resulting from a change in the shooting condition, and thus to realize an image taking apparatus that can discriminate different types of image precisely.

Here, the discrimination controlling element may make the discriminating element determine the type of the image again when the shooting condition changes out of a predetermined range. This makes it possible to prevent the type of the image from being re-determined in response to a slight change in the shooting condition, and thus to prevent unnecessary re-discrimination when the type of the image does not change.

The discrimination controlling element may make the discriminating element determine the type of the image again when a change in the shooting condition persists longer than a predetermined period of time. This makes it possible to prevent re-discrimination when a change in the shooting condition is temporary and the original shooting condition is restored immediately, as when the users' hands holding the image taking apparatus shake.

The discrimination controlling element may make the discriminating element determine the type of the image again when the change in the shooting condition remains within a predetermined range for a predetermined period of time. This makes it possible to determine the type of the image again when the shooting condition has become stable after a change therein. If re-discrimination is performed while the shooting condition is changing, the type of the image is likely to change further, and thus the obtained discrimination result tends to be meaningless. By determining the type of the image again when the shooting condition has become stable, it is possible to obtain a meaningful discrimination result without fail.

The image taking apparatus may be further provided with an indicating element for displaying information indicating the type of the image determined by the discriminating element. This makes it easy for the user to confirm the result of image type discrimination by the image taking apparatus. When re-discrimination is performed, displaying the result permits the user to be kept informed of the latest discrimination result.

The image taking apparatus may be further provided with a shooting controlling element for controlling the operation performed when the image is taken according to the type of the image determined by the discriminating element. This permits the determined type of the image to be reflected in the image that is going to be taken, and thus makes it possible to obtain an image rendered appropriately according to what appears in it. Since the type of the image can be re-determined when the shooting condition changes, even if the type of the image changes as a result of a change in the shooting condition, it is possible to obtain an appropriately rendered image without fail.

The shooting controlling element may control at least one of exposure adjustment, flashing, gamma correction, sharpness adjustment, and color correction. These are all factors that directly affect the quality of the obtained image, and thus their appropriate control is useful to obtain an appropriate image that suits the type of the image.

The shooting condition detected by the detecting element may be at least one of shooting magnification, taking lens focal length, subject movement, subject brightness, and color balance. These are all shooting conditions that greatly affect what appears in the image taken, and are thus suitable as criteria for discriminating different types of image. Combining these shooting conditions makes it possible to classify images finely.

According to another aspect of the present invention, an image taking apparatus in which a plurality of different types of image are previously defined to correspond to different shooting conditions so that a type of an image to be taken is determined according to the shooting condition under which the image is going to be taken is provided with: a detecting element for detecting the shooting condition; a discriminating element for determining the type of the image according to the shooting condition detected by the detecting element; a triggering element for instructing the discriminating element to determine the type of the image; and a discrimination controlling element for switching states of the discriminating element between a state in which it determines the type of the image only once in response to an instruction from the triggering element and a state in which it determines the type of the image repeatedly in response to an instruction from the triggering element.

In this image taking apparatus, the discriminating element for discriminating different types of image can operate either in the first or second state by being switched by the discrimination controlling element. The discriminating element determines the type of the image, in the first state, only once in response to an instruction from the triggering element and, in the second state, not only once but repeatedly thereafter in response to an instruction from the triggering element. Thus, with the discriminating element kept in the second state, when the shooting condition changes, it is possible to determine the type of the image precisely according to the change. On the other hand, with the discriminating element kept in the first state, even when the shooting condition changes, it is possible to maintain the type of the image determined at the time of an instruction from the triggering element.

Here, the image taking apparatus may be further provided with an indicating element for displaying information indicating the type of the image determined by the discriminating element. This permits the user to confirm the type of the image determined by the apparatus, and makes it easy for the user to check whether the determined type of the image is appropriate or not.

The indicating element may display information indicating the type of the image anew every time the type of the image determined by the discriminating element changes. This permits the user to confirm the type of the image most recently determined by the apparatus, and thus permits the user to judge whether the determined type of the image is appropriate or not precisely all the time.

The image taking apparatus may be further provided with a shooting controlling element for controlling the operation performed when the image is taken according to the type of the image determined by the discriminating element. With the discriminating element kept in the first state, the type of the image determined at the time of an instruction from the trigger element is, regardless of whether or not the shooting condition has changed thereafter, reflected in the image that is going to be taken. With the discriminating element kept in the second state, the type of the image most recently determined is reflected in the image that is going to be taken. Thus, according to in which state the discriminating element is kept, it is possible to choose whether to reflect a change in the shooting condition in the image to be taken or not.

Here, the shooting controlling element may control at least one of exposure adjustment, flashing, gamma correction, sharpness adjustment, and color correction.

The shooting condition detected by the detecting element may be at least one of shooting magnification, taking lens focal length, subject movement, subject brightness, and color balance.

According to still another aspect of the present invention, an image taking apparatus that automatically focuses a taking lens on a subject and in which a plurality of different types of image are previously defined to correspond to different shooting conditions so that the type of an image to be taken is determined according to the shooting condition under which the image is going to be taken is provided with: an adjusting element for adjusting the focus of the taking lens to the subject; a detecting element for detecting the shooting condition; a discriminating element for determining the type of the image according to the shooting condition detected by the detecting element; a triggering element for making the adjusting element start adjusting the focus of the taking lens and for instructing the discriminating element to determine the type of the image; an operation element operated by a user to specify the type of the image; and an adjustment controlling element for making the adjusting element continue adjusting the focus of the taking lens even after the taking lens has been focused on the subject and for stopping the adjusting element from adjusting the focus of the taking lens when the operation element is operated.

In this image taking apparatus, even after the taking lens has been focused on the subject, the adjustment controlling element makes the adjusting element continue adjusting the focus of the taking lens, achieving continuous AF. However, when the operation element is operated, the adjustment controlling element makes the adjusting element stop adjusting the focus of the taking lens. Thus, when the user specifies the type of the image, continuous AF is suspended, with the focus locked. With continuous AF suspended, it is possible to exercise control according to the type of the image specified by the user under the focus condition at the time of the user's operation. This permits the user's intention to be reflected in the actually exercised control without fail. When the user does not specify the type of the image after operating the operation element, it is possible to exercise control according to the type of the image previously determined under the focus condition at the time of the user's operation.

The image taking apparatus may be further provided with a discrimination controlling element for detecting, after the discriminating element has determined the type of the image, a change in the shooting condition detected by the detecting element in order to make the discriminating element determine the type of image again. This makes it possible to determine the type of the image again according to the movement of the subject, and thus helps obtain a precise discrimination result all the time, enhancing the significance of combining continuous AF with image type discrimination. When the user operates the operation element but does not specify the type of the image, it is possible to restart continuous AF. Even then, by determining the type of the image again according to the movement of the subject, it is possible to obtain a precise discrimination result.

The image taking apparatus may be further provided with an indicating element for displaying information indicating the type of the image determined by the discriminating element and for indicating, when the type of the image is specified by the user, information indicating the type of the image specified. This permits the user to confirm the type of the image determined by the image taking apparatus, and makes it easier for the user to decide whether or not to specify the type of the image by him or herself. Moreover, it is also possible to confirm the type of the image so specified.

The image taking apparatus may be further provided with a shooting controlling element for controlling the operation performed when the image is taken according to, when the type of the image is specified by the user, the type of the image specified and, when the type of the image is not specified by the user, the type of the image determined by the discriminating element. This permits the type of the image specified or determined to be reflected in the image that is going to be taken, and thus makes it possible to obtain an image rendered appropriately according to what appears in it.

The shooting controlling element may control at least one of exposure adjustment, flashing, gamma correction, sharpness adjustment, and color correction.

The shooting condition detected by the detecting element may be at least one of shooting magnification, taking lens focal length, subject movement, subject brightness, and color balance.

According to a further aspect of the present invention, an image taking apparatus is provided with: an acquiring element for acquiring shooting information; a discriminating element for determining the type of an image to be taken according to the shooting information; a focusing element for performing focusing on a subject; a focusing controlling element for continuously operating the focusing element; an overriding element for manually overriding the determined type of the image; and an inhibiting element for inhibiting the operation of the focusing controlling element when the type of the image is overridden by the overriding element during continuous focusing operation in which the focusing element is continuously operated by the focusing controlling element.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a perspective view of a digital camera embodying the invention;

FIG. 2 is a rear view of the digital cameras of a first and a third embodiment of the invention;

FIG. 3 is a block diagram showing an outline of the circuit configuration of the digital cameras of the embodiments;

FIG. 4 is a diagram showing the shooting conditions used for the classification and determination of the type of an image and the control exercised according thereto in the digital cameras of the embodiments;

FIGS. 5A and 5B are diagrams showing examples of the indication of the type of an image determined in the digital cameras of the embodiments;

FIGS. 6A and 6B are diagrams showing other examples of the indication of the type of an image determined in the digital cameras of the embodiments;

FIGS. 7A and 7B are diagrams showing an example of the indication of the type of an image specified in the digital cameras of the embodiments;

FIGS. 8A, 8B, and 8C are diagrams showing examples of the ranges used to evaluate changes in shooting conditions in the digital camera of the first embodiment;

FIG. 9 is a diagram showing an example of the permissible variation range used to evaluate the stability of a shooting condition in the digital camera of the first embodiment;

FIG. 10 is a flow chart showing the flow of operation performed to determine the type of an image in the digital camera of the first embodiment;

FIG. 11 is a flow chart showing another example of the flow of operation performed to determine the type of an image in the digital camera of the first embodiment;

FIG. 12 is a rear view of the digital camera of a second embodiment of the invention;

FIG. 13 is a flow chart showing the flow of operation performed to determine the type of an image in the digital camera of the second embodiment; and

FIG. 14 is a flow chart showing the flow of operation performed to determine and specify the type of an image in the continuous AF, automatic discrimination mode in the digital camera of the third embodiment.

### DESCRIPTION OF THE PREFERRED EMBODIMENTS

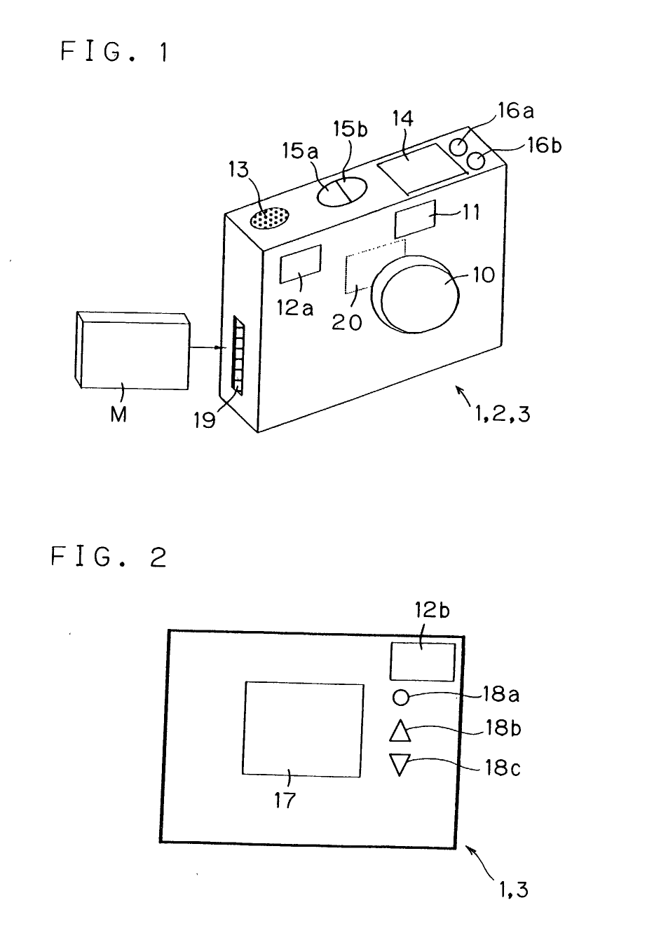

Hereinafter, embodiments of the present invention will be described with reference to the drawings. The appearance of the digital camera 1 of a first embodiment of the invention is schematically shown in a perspective view of FIG. 1 and a rear view of FIG. 2. The digital camera 1 includes the following components. On the front face are arranged a taking lens 10, a flash 11, and the front window 12a of a viewfinder. On the top face are arranged a release button 13, a liquid crystal panel 14, and operation keys 15a, 15b, 16a, and 16b. On the rear face are arranged a large liquid crystal panel 17, operation keys 18a, 18b, and 18c, and the rear window 12b of the viewfinder. On a side face is arranged a recording medium slot 19. In the interior is arranged an image sensor 20.

In the digital camera 1, the light from the targets to be shot is imaged by the taking lens 10 on the image sensor 20 so that the image sensor 20 is exposed to the light, and, from the signals output from the image sensor 20, image data representing an image is generated, achieving the shooting of the image. The image sensor 20 is a CCD-type device having a large number of pixels arranged in a two-dimensional array, and, for each pixel, performs photoelectric conversion and outputs a signal representing the electric charge accumulated thereby. The output signals from the individual pixels represent the amounts of light received from the corresponding points on the shooting targets. These signals are first digitized, and are then subjected to various kinds of processing so as to be converted into image data representing the image taken. Each pixel is provided with a color filter that selectively transmits red (R), green (G), or blue (B) light, so that all the pixels are classified into those for R light, those for G light, and those for B light.

The image data generated is recorded on a recording medium M inserted in the recording medium slot 19, and the image represented by the image data is displayed on the liquid crystal panel 17. The shooting of the image, i.e., the process from the exposure of the image sensor 20 to the generation of the image data, is repeated at substantially regular time intervals, and, in response to an instruction given meanwhile, the image data is recorded on the recording medium M. Even when no recording is made on the recording medium M, the image represented by the image data is displayed on the liquid crystal panel 17 to offer a live view to the user. The instruction requesting the recording of the image data is given by operation of the release button 13.

The image data recorded on the recording medium M can be read out to reproduce and display the image it represents on the liquid crystal panel 17. The shooting of an image and the display of a reproduced image can be switched by operation of the operation key 16a.

The taking lens 10 is a zoom lens of which the focal length is variable. The focal length of the taking lens 10 is varied to the longer focal length side by operation of the operation key 15a and to the shorter focal length side by operation of the operation key 15b.

The taking lens 10 is provided with an aperture stop (not shown) of which the aperture diameter is variable. Thus, the exposure of the image sensor 20 is controlled by adjusting the aperture diameter of the aperture stop and the photoelectric conversion time of the image sensor 20, i.e., the shutter speed. In the digital camera 1, the exposure of the image sensor 20 is controlled in one of three modes, namely aperture-priority, shutter-speed-priority, and program modes.

In the aperture-priority mode, the aperture diameter of the aperture stop is set so that the f-number specified by the user is obtained, and the shutter speed is adjusted according to the brightness of the shooting targets. In the shutter-speed-priority mode, the photoelectric conversion time of the image sensor 20 is set so that the shutter speed specified by the user is obtained, and the aperture diameter of the aperture stop is adjusted according to the brightness of the shooting targets. In the program mode, both the aperture diameter of the aperture stop and the photoelectric conversion time of the image sensor are adjusted so that the f-number and the shutter speed previously defined according to the brightness of the shooting targets are obtained. The user can switch the exposure modes and specify the f-number or shutter speed by operation of the operation key 16b. The brightness of the shooting targets is determined from the intensity of the output signals of the image sensor 20.

The digital camera 1 has an automatic focusing capability that permits the taking lens 10 to be automatically focused on the subject, i.e., the main shooting target. Automatic focusing is achieved by determining the amount of defocus, i.e., the distance between the subject image and the image sensor 20, by a method based on phase difference detection, and then setting the focus of the taking lens 10 at a position where the amount of defocus is zero. Automatic focusing may be achieved by any other method, for example, by a hill-climbing servo method in which, while the contrast of the image on the image sensor 20 is being monitored, the focus of the taking lens 10 is moved in the direction in which the contrast of the portion of the image corresponding to the subject increases so that the focus is gradually brought to the subject.

The release button 13, when pressed halfway, produces a first signal (called the signal S1) and, when pressed fully, produces a second signal (called the signal S2) as well. The signal S1 requests the starting of automatic focusing and of the detection of the brightness of the shooting targets. The signal S2 requests the recording of the image data.

The liquid crystal panel 14 displays the settings made in the digital camera 1, operation guides, and the like. The operation keys 18a to 18c are used in connection with the determination and specification of image type, as will be described later.

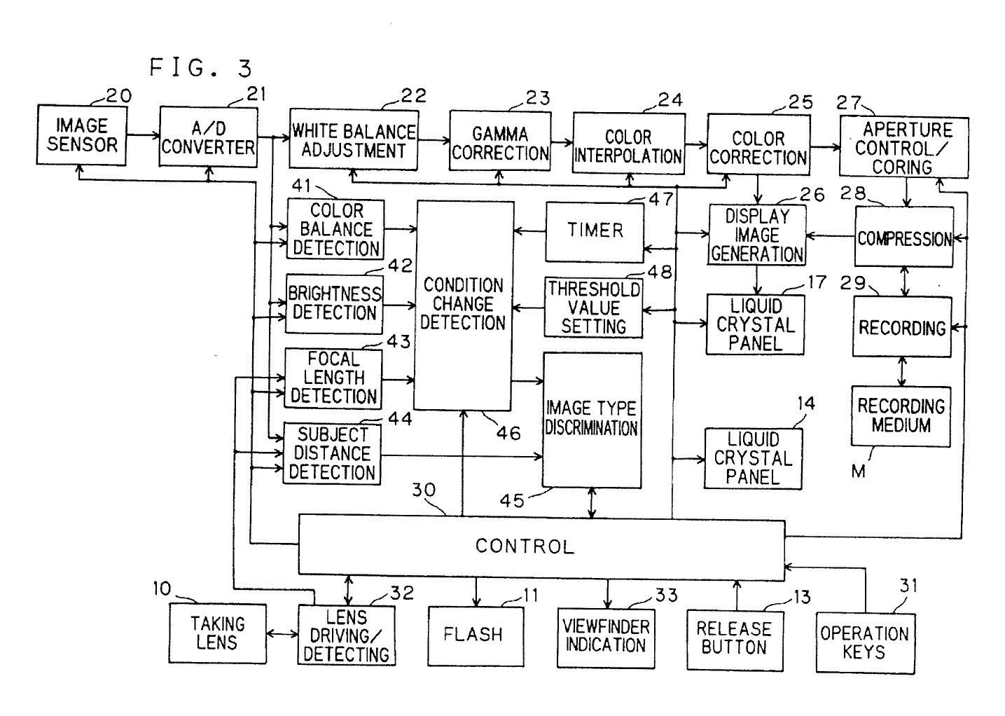

FIG. 3 schematically shows an outline of the circuit configuration of the digital camera 1. The digital camera 1 includes an A/D converter 21, a white balance adjustment portion 22, a gamma correction portion 23, a color interpolation portion 24, a color correction portion 25, a display image generation portion 26, an aperture control/coring portion 27, a compression portion 28, and a recording portion 29. These blocks take care of the generation and recording of image data and the display of images.

The A/ID converter 21 converts the output signals of the image sensor 20, which are analog signals, into digital signals. The white balance adjustment portion 22 adjusts the levels of the signals of R, G, and B color components individually to adjust the white balance. The gamma correction portion 23 performs non-linear processing on the signals to make them suitable for display. The color interpolation portion 24 produces the signal of the R, G, or B color component missing at each pixel by interpolation. The color correction portion 25 adjusts the levels of the signals of the R, G, and B color components individually to correct the colors of the image after the adjustment of its white balance.

The display image generation portion 26 extracts, from all the signals, a predetermined proportion thereof suitable for display on the liquid crystal panel 17 having fewer pixels than the image sensor 20 in order to generate image data to be fed to the liquid crystal panel 17 for display. The aperture control/coring portion 27 performs edge enhancement/softening on the image data to be recorded, and adjusts the noise level therein. The compression portion 28 compresses the image data by a method conforming to JPEG. The recording portion 29 takes care of the input and output to and from the recording medium M. When an image is reproduced for display, the compression portion 28 performs processing opposite to compression on the image data read out from the recording medium M to reproduce the original image data.

The digital camera 1 includes a control portion 30, a lens driving/detecting portion 32, and a viewfinder indication portion 33. The control portion 30 is composed of a CPU, and controls the operation of the entire digital camera 1. The control portion 30 is connected to the release button 13 and to a group of operation keys 31 including the keys 15a, 15b, 16a, 16b, and 18a to 18c, and exercises control according to how there are operated. The lens driving/detecting portion 32 adjusts the focal length, the focus, and the aperture stop of the taking lens 10, and also detects their settings. The viewfinder indication portion 33 is disposed between the front window 12a and the rear window 12b of the viewfinder, and indicates information in a peripheral portion of the optical image observed through the viewfinder.

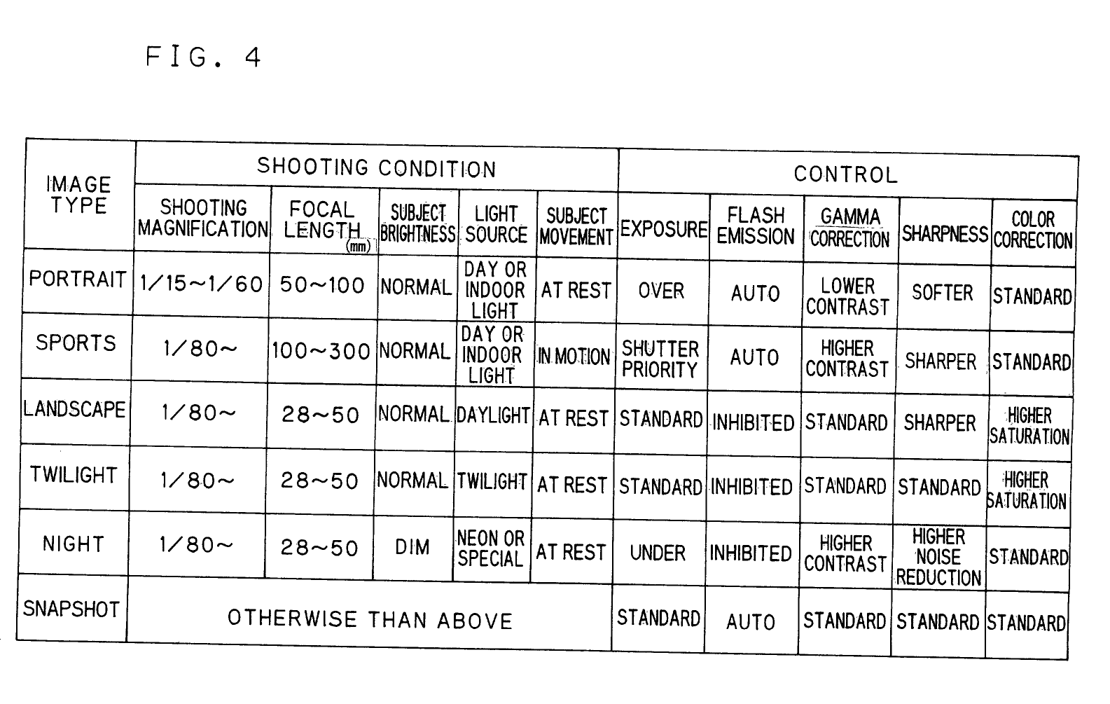

The digital camera 1 has a capability of determining the type of an image to be taken by classifying, according to the shooting conditions under which the image is going to be taken, the image into one of a plurality of types previously defined to correspond to different sets of shooting conditions. The different types of image are classified not only on the basis of the scene in which the image is going to be taken, i.e., the state of the shooting targets, but so as to correspond to different sets of shooting conditions including variable parameters of the digital camera 1 itself FIG. 4 shows the correspondence between the types of image classified and the shooting conditions used to discriminate them. Here, six types of image are discriminated, namely “portrait,” “sports,” “landscape,” “twilight scene,” “night scene,” and “snapshot.” Used to discriminate these types of image, i.e., associated with them, are five shooting conditions, namely the shooting magnification, the focal length of the taking lens 10, the brightness of the subject, the type of the light source, and whether the subject is in motion or at rest.

The user can specify the image type. Specifically, the user can judge by him or herself to which of the above six types the image is to be classified and enter the choice in the digital camera 1. That is, the digital camera 1 operates in one of two modes, namely an automatic discrimination mode in which the image type is automatically determined by the digital camera 1 itself and a manual specification mode in which it is specified by the user. These modes are switched by operation of the operation key 1 8a. In the manual specification mode, which type of image to specify is switched by operation of the operation keys 18b and 18c.

When the image is actually taken, control is exercised differently according to the image type determined or specified. This is to offer an image rendered appropriately according to what appears in it. FIG. 4 also shows the correspondence between the different types of image and the factors controlled. The factors controlled here are the exposure of the image sensor 20, the flash light emission by the flash 11, the gamma correction by the gamma correction portion 23, the image sharpness and noise level adjustment by the aperture control/coring portion 27, and the color correction by the color correction portion 25.

In the automatic discrimination mode, the image type is determined at the end of automatic focusing, i.e., when the taking lens 10 is focused on the subject. Accordingly, the image type is determined every time the release button 13 is pressed halfway and the signal S1 is produced. However, in the digital camera 1, even after the image type is determined at the end of automatic focusing, when there occurs a change in the shooting conditions, the image type is re-determined according to the change.

As shown in FIG. 3, the digital camera 1 includes, for the purpose of determining and re-determining the image type, a color balance detection portion 41, a brightness detection portion 42, a focal length detection portion 43, a subject distance detection portion 44, an image type discrimination portion 45, a condition change detection portion 46, a timer 47, and a threshold value setting portion 48.

The color balance detection portion 41 detects the color balance of the image on the image sensor 20 on the basis of the output signals of the A/D converter 21. Specifically, it calculates the average of the signal intensity of all the signals for each of the R, G, and B color components, and then calculates the ratio RIG of the R color component average signal intensity to the G color component average signal intensity and the ratio B/G of the B color component average signal intensity to the G color component average signal intensity.

The brightness detection portion 42 detects the brightness of the subject on the basis of the output signals of the A/D converter 21. The focal length detection portion 43 detects the focal length of the taking lens 10 on the basis of the output of the lens driving/detecting portion 32. The subject distance detection portion 44 determines the amount of defocus on the basis of the output signals of the A/D converter 21, and detects the distance to the subject on the basis of the thus determined amount of defocus and the information indicating the focal position of the taking lens 10 included in the output from the lens driving/detecting portion 32. It also detects the amount of movement of the subject on the basis of the variation in the distance to the subject and the variation in the position of the subject image (the portion of the image on the image sensor 20 that was used to determine the amount of defocus).

The values detected by the color balance detection portion 41, brightness detection portion 42, and focal length detection portion 43 are fed through the condition change detection portion 46 to the image type discrimination portion 45, and the value detected by the subject distance detection portion 44 is fed directly to the image type discrimination portion 45. The image type discrimination portion 45 calculates the shooting magnification on the basis of the focal length and the distance to the subject, determines the type of the light source on the basis of the two signal intensity ratios R/G and B/G, and judges to which type of image corresponds the combination of the five shooting conditions including these and other detected values. The image type determined by the image type discrimination portion 45 is fed to the control portion 30 so as to be used to control the exposure of the image sensor 20 and the generation of image data by the blocks from the white balance adjustment portion 22 to the aperture control/coring portion 27. At the end of automatic focusing, the control portion 30 instructs the image type discrimination portion 45 to determine the image type.

The condition change detection portion 46 feeds the detected values from the color balance detection portion 41, brightness detection portion 42, and focal length detection portion 43 to the image type discrimination portion 45, and detects changes in those detected values. When the condition change detection portion 46 detects such a change, it checks whether the change meets predetermined conditions or not, and, if so, it instructs the image type discrimination portion 45 to determine the image type. The detection of the shooting conditions by the blocks from the color balance detection portion 41 to the subject distance detection portion 44 and the detection of changes in the shooting conditions by the condition change detection portion 46 are performed repeatedly, and meanwhile the condition change detection portion 46, whenever necessary, instructs the image type discrimination portion 45 to perform image type discrimination. Every time the image type discrimination portion 45 receives an instruction requesting image type discrimination from the condition change detection portion 46, it determines the image type.

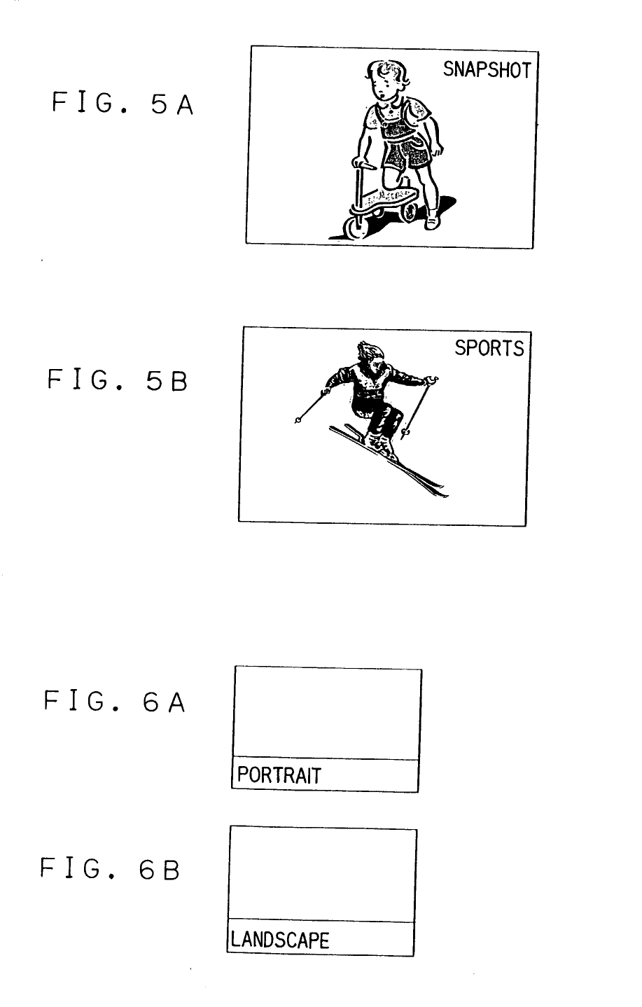

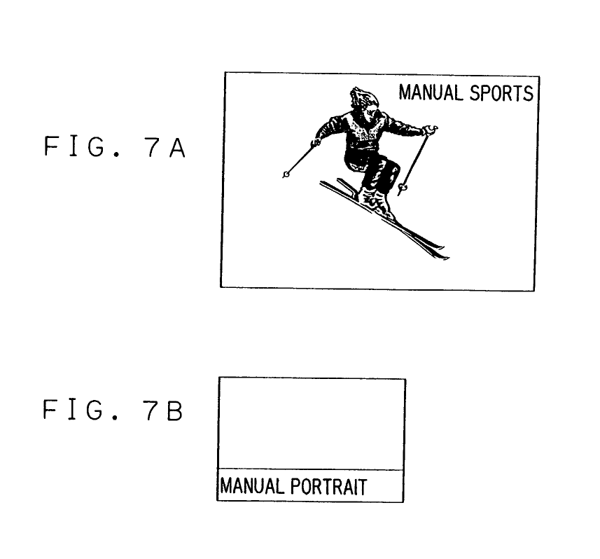

The control portion 30 displays on the liquid crystal panel 17 and the viewfinder indication portion 33 the image type determined by the image type discrimination portion 45 in the automatic discrimination mode or specified by the user in the manual specification mode. Examples of display are shown in FIG. 5A to 7B. FIGS. 5A and 5B show examples of display on the liquid crystal panel 17, where the image type is displayed by name along with a live view. While FIG. 5A shows a case where the image type is recognized as “snapshot,” FIG. 5B shows a case where it is recognized as “sports.” FIGS. 6A and 6B are examples of display on the viewfinder indication portion 33, where the image type is displayed in a peripheral portion of an optical image (not shown). FIGS. 6A and 6B show cases where the image type is recognizes as “portrait” and “landscape,” respectively.

FIGS. 7A and 7B show examples of the display of the image type specified by the user on the liquid crystal panel 17 and the viewfinder indication portion 33, respectively. The image type specified in the manual specification mode is displayed along with an indication “manual” so as to be distinguished from that determined in the automatic discrimination mode.

Here, the image type is indicated by name, and different indications are displayed according to the image type. However, the image type may be indicated in any other manner. For example, it is also possible to display different symbols corresponding to the different types of image, or display the names of all of the six types of image simultaneously along with a pointer pointing one of them according to the image type determined or specified. It is also possible to place a small lamp in a peripheral portion of the rear window 12b of the viewfinder so that, in the manual specification mode, the lamp is lit to indicate the mode chosen. This makes it possible to omit the indication “manual” from the display.

In the automatic discrimination mode, although the digital camera 1 determines the image type, the user can confirm the discrimination result by looking at the display. Thus, the user can decide by him or herself whether or not to exercise control, when an image to be recorded is going to be taken, according to the discrimination result or not. If the discrimination result is inconsistent with his or her intention, the user can switch to the manual specification mode by operating the operation key 18a and specify the desired type of image by operating the operation keys 18b and 18c.

As described earlier, the condition change detection portion 46, according to changes in the values detected by the color balance detection portion 41, brightness detection portion 42, and focal length detection portion 43, instructs the image type discrimination portion 45 to determine the image type. Here, whether to give an instruction requesting image type discrimination or not is determined by evaluating changes in the detected values by the first or second of the methods listed below, and when to give it is determined by the third or fourth of the methods listed below:

First Method: When there occurs a change in the values detected by the detection portions 41 to 43, irrespective of the magnitude of the change, an instruction requesting image type discrimination is given;

Second Method: When there occurs a change in the values detected by the detection portions 41 to 43 that involves a shift from one predefined range to another, an instruction requesting image type discrimination is given;

Third Method: When a change in the values detected by the detection portions 41 to 43 persists for a predetermined period of time, an instruction requesting image type discrimination is given; and

Fourth Method: When the values detected by the detection portions 41 to 43 become stable after a change in them, an instruction requesting image type discrimination is given.

Either of the first and second methods can be freely combined with either of the third and fourth methods. Now, each of these methods will be described specifically.

First Method

By this method, the image type is determined unless no change is observed in any of the color balance, subject brightness, and focal length. Thus, the image type discrimination portion 45 is required to perform much calculation for image type discrimination. By combining this method with the third or fourth method, however, it is possible to avoid keeping the image type discrimination portion 45 determining the image type all the time.

Second Method

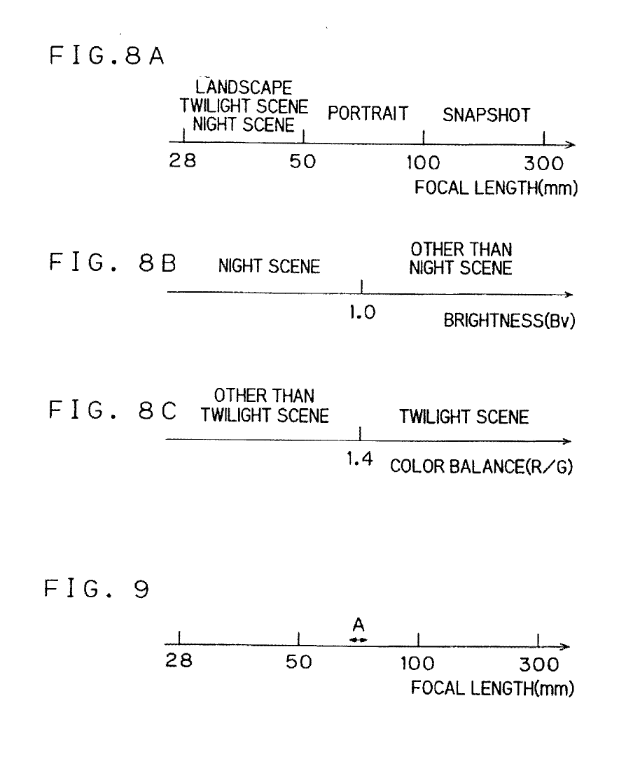

As shown in FIG. 4, the focal length of the taking lens 10 is divided into three ranges according to the image type, namely “from 28 to 50 mm,” “from 50 to 100 mm,” and “from 100 to 300” mm. The subject brightness is divided into two ranges, namely “normal” and “dim,” with the borderline set at where the Bv value equals 1.0. The color balance, corresponding to the type of the light source, is divided into two range, namely “daylight or indoor light” and “twilight,” with the borderline set at where the signal intensity ratio R/G between the R and G color components equals 1.4. FIGS. 8A to 8C show these ranges of the shooting conditions.

By the second method, whether any of the detected values of the focal length, subject brightness, and color balance has so varied as to shift from one of the ranges described above to another or not is checked so that, when any of the detected values has varied past any of the borderline values between the ranges, an instruction requesting image type discrimination is fed to the image type discrimination portion 45. Thus, with this method, the result of image type discrimination is more likely to change. Moreover, compared with the first method, this method requires the image type discrimination portion 45 to perform less calculation. The borderline values of the focal length, subject brightness, and color balance are stored in the threshold value setting portion 48.

Third Method

By the third method, when a predetermined period of time has elapsed since one of the detected values started to change, whether the change in the detected value still persists or not is checked, and, if the change persists, an instruction requesting image type discrimination is fed to the image type discrimination portion 45. The predetermined period of time is about 0.5 to 2 seconds. This predetermined period of time is also stored in the threshold value setting portion 48. A lapse of time is measured by the timer 47.

With this method, even when a change occurs in the detected values, if the original detected values are restored within the predetermined period of time, the image type is not determined. For example, even when the user's hands shake, changing the orientation of the digital camera 1 and temporarily changing the color balance, no image type discrimination is performed. Thus, when this method is combined with the first method by which an instruction requesting image type discrimination is given even when only a slight change is observed in the detected values, the image type is determined in most cases at predetermined time intervals. On the other hand, when this method is combined with the second method by which an instruction requesting image type discrimination is given when any of the detected values changes out of a range, even when any of the detected values changes out of a range, as long as the change is temporary, the image type is not re-determined.

By reducing the frequency of image type discrimination in this way, it is possible to prevent excessively frequent change of the display on the liquid crystal panel 17 and the viewfinder indication portion 33. It is also possible to prevent excessively frequent change of the display by giving an instruction requesting image type discrimination to the image type discrimination portion 45 without waiting for the predetermined period of time to lapse after the detected values started to change, but refresh the display when the predetermined period of time has elapsed since the detected values started to change. However, doing so requires much calculation to be performed for image type discrimination that turns out to be useless, increasing power consumption. Therefore, it is preferable to adopt the third method by which no image type discrimination is performed at all within the predetermined period of time.

Fourth Method

By the fourth method, for each of the detected values of the focal length, subject brightness, and color balance, a permissible variation range is set so that, when changes in the detected values remain within their respective permissible variation ranges for a predetermined period of time, they are regarded as stable, and an instruction requesting image type discrimination is fed to the image type discrimination portion 45. If the image type is determined while the detected values are varying, the image type is likely to change thereafter, making the discrimination result useless. This can be avoided by adopting the fourth method.

For example, in a case where the user varies the angle of view by zooming, even when the focal length of the taking lens 10 stops varying, if, within a predetermined period of time (for example, one second), the focal length varies out of the permissible variation range (for example, ±5 mm), no instruction requesting image type discrimination is given. This helps prevent image type discrimination from being performed while the shooting target area is varying, including the period for fine-adjustment of the focal length at the end of zooming.

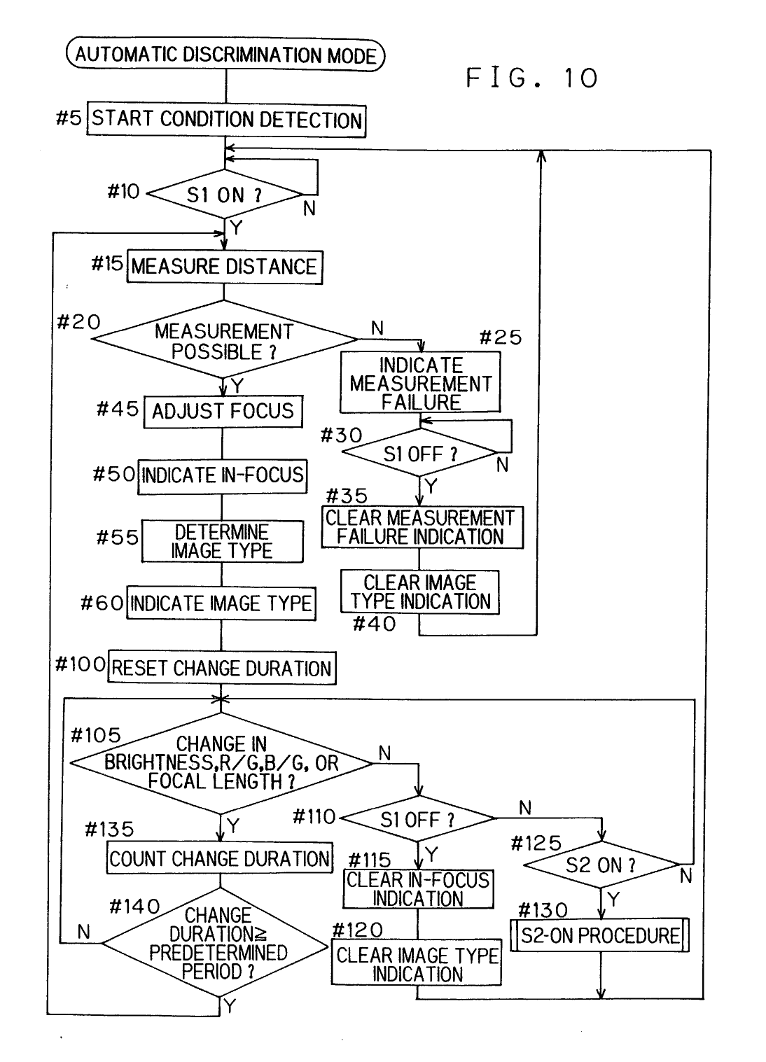

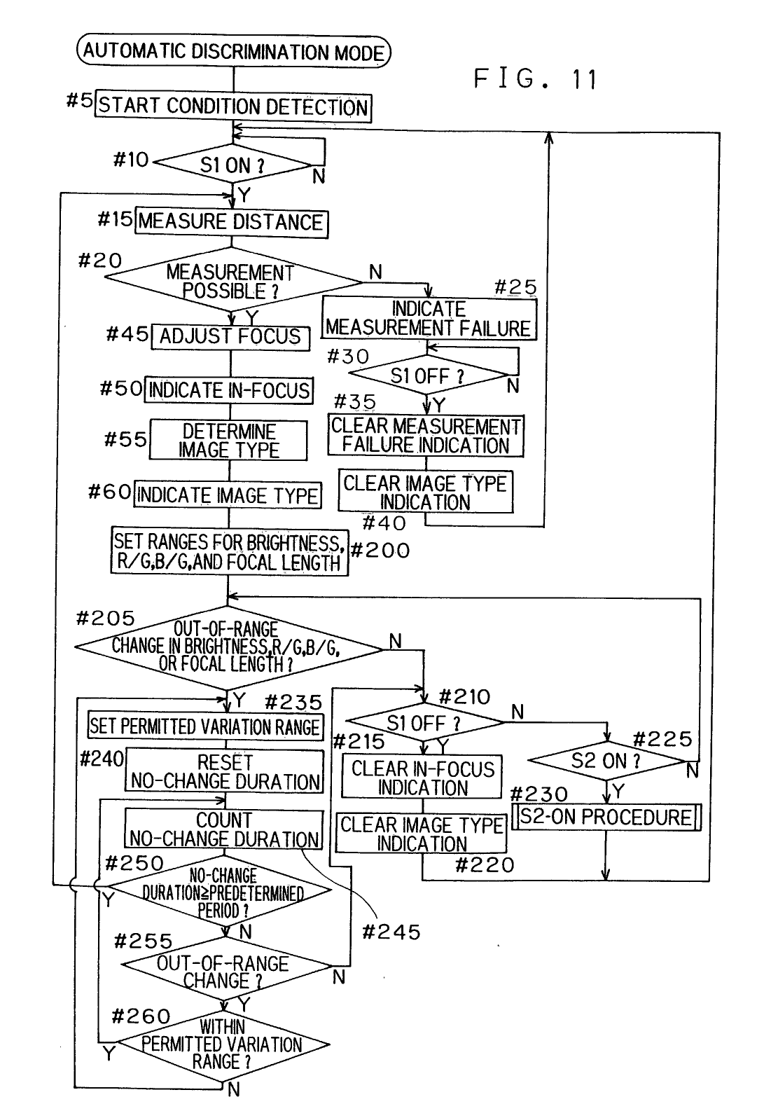

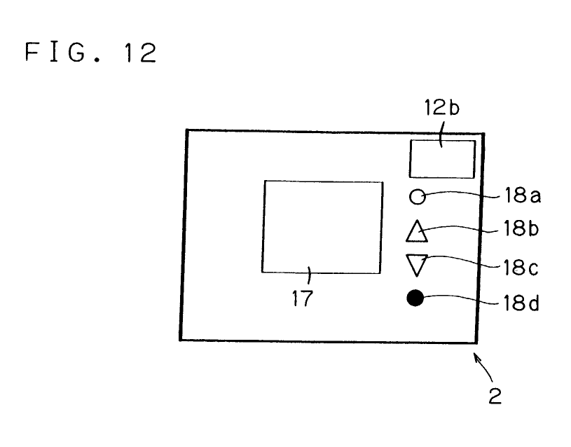

FIG. 9 shows an example of the permissible variation range, taking up the focal length here. The permissible variation range A is different from the ranges used with the second method; specifically, the former is narrower than the latter. The permissible variation range is set separately for each shooting condition, and may be constant or variable. When it is made variable, it may be defined as a proportion relative to the detected value, like within a 5% deviation therefrom, or may be defined differently for each of the ranges used with the second method.

Now, the flow of operation performed to determine the image type in the digital camera 1 will be described with reference to flow charts. FIG. 10 is a flow chart applied when the first and third methods are combined. When the automatic discrimination mode is established, first, the shooting conditions (the color balance (R/G and B/G), subject brightness, and focal length) start being detected by the color balance detection portion 41, brightness detection portion 42, and focal length detection portion 43 (step #5). Next, whether the signal S1 is present or not is checked, and, if the signal S1 is absent, a wait lasts until the release button 13 is pressed halfway and the signal S1 is produced (#10).

If the signal S1 is present, the distance to the subject is measured (i.e., the amount of defocus is detected) by phase difference detection (#15), and then whether it is possible to perform the measurement or not is checked (#20). If it is impossible to perform the measurement because of low contrast, a message to that effect is displayed on the liquid crystal panel 17 and the viewfinder indication portion 33 (#25), and then a wait lasts until the signal S1 disappears (#30). When the release button 13 is let loose and the signal S1 disappears, the message indicating the failure of the measurement is cleared (#35), the indication of the image type is also cleared (#40), and then the flow returns to step #10. It is to be noted that the shooting of the image and the display of the live view is started before the automatic discrimination mode is established, and that the live view keeps being displayed throughout.

If it is possible to perform the measurement of the subject distance, the focus of the taking lens 10 is adjusted to the subject (#45), and, when the subject is in focus, a message to that effect is displayed on the liquid crystal panel 17 and the viewfinder indication portion 33 (#50). The image type discrimination portion 45 then performs calculation for image type discrimination (#55), and the determined image type is displayed on the liquid crystal panel 17 and the viewfinder indication portion 33 (#60).

Next, for the third method, a change duration, which represents the period of time that has elapsed after a change occurred in the detected values, is reset to zero (#100), and then whether there is any change nor not in the values of the color balance, subject brightness, and focal length detected by the color balance detection portion 41, brightness detection portion 42, and focal length detection portion 43 is checked (#105).

If, in step #105, no change is observed in any of the detected values, then whether the signal S1 is present or not is checked (#110). If the signal S1 is absent, the message indicating that the subject is in focus is cleared (#115), the indication of the image type is also cleared (#120), and the flow returns to step #10. If the signal S1 is present, then whether the signal S2 is present or not is checked (#125), and, if the signal S2 is absent, the flow returns to step #105.

If the release button 13 is pressed fully and the signal S2 is produced, an S2-on procedure, which includes operations from the exposure of the image sensor 20 to the generation of image data and its recording on the recording medium M performed by the blocks from the A/D converter 21 to the recording portion 29, is executed (#130), and then the flow returns to step #10. In the S2-on procedure executed in step #130, the operations from exposure to image data generation are controlled according to the image type that has been determined.

If, in step #105, a change is observed in any of the detected values, the change duration is counted (#135). The change duration is counted by starting the timer 47 in step #100 and reading its output. Next, whether the change duration is equal to or longer than a predetermined period of time or not is checked (#140). If it is shorter than the predetermined period of time, the flow returns to step #105; if it is equal to or longer than the predetermined period of time, the flow returns to step #15.

In this flow of operation, when automatic focusing is performed for the first time (#45), the image type is determined (#55), and thereafter, when a change occurs in the detected values of the color balance, focal length, and the like, the image type is re-determined (#55). Here, in response to a change in the detected values, the image type is re-determined, by the third method, only when the change persists for the predetermined period of time (#140). Moreover, when a change occurs in the detected values and the image type is re-determined, automatic focusing is also performed (#45). Thus, automatic focusing is performed here as continuous AF. It is, however, also possible to inhibit automatic focusing once the subject is in focus by modifying the flow so that it returns from step #140 not to #15 but to #55.

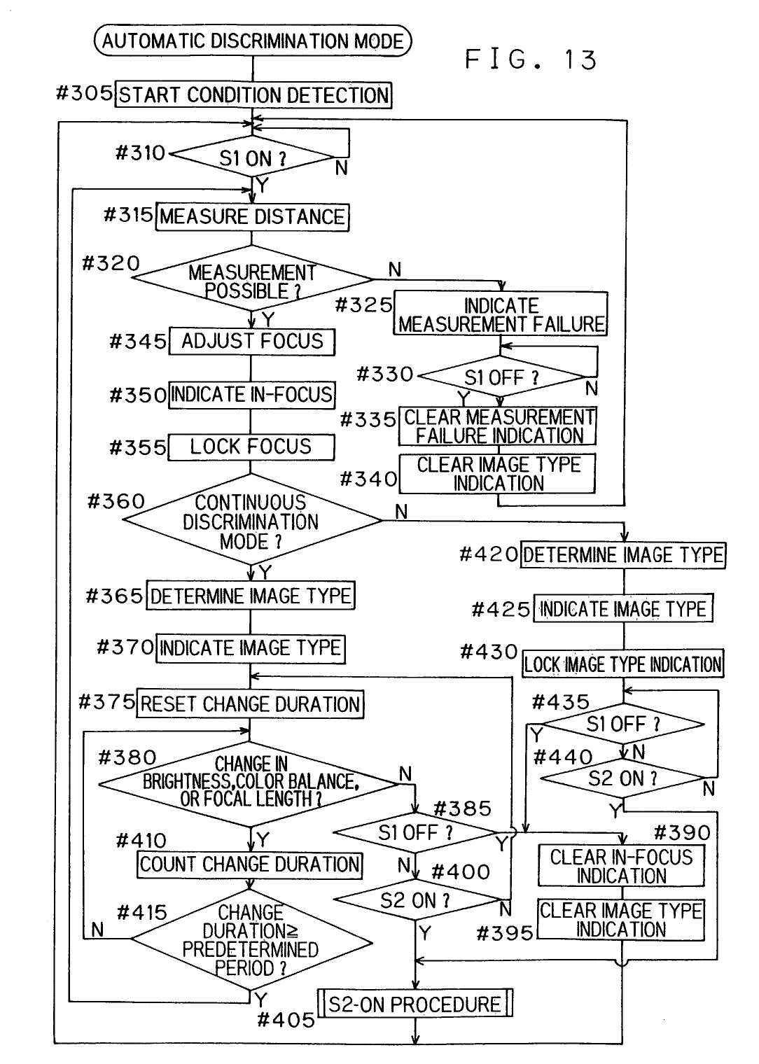

FIG. 11 is a flow chart applied when the second and fourth methods are combined. Here, steps #5 to #60 are the same as in FIG. 10, and therefore overlapping explanations will be omitted. At the end of automatic focusing, the image type is determined (#55), and the determined image type is indicated (#60). Then, for the second method, the ranges of values for the color balance, subject brightness, and focal length are set (#200). Then, whether any of the values of the color balance, subject brightness, and focal length detected by the color balance detection portion 41, brightness detection portion 42, and focal length detection portion 43 has varied out of the range in which it was in step #55 into another range or not is checked (#205).

If all the detected values remain in the same ranges as before, then whether the signal S1 is present or not is checked (#210). If the signal S1 is absent, the message indicating that the subject is in focus is cleared (#215), the indication of the image type is cleared (#220), and the flow returns to step #10. If the signal SI is present, then whether signal S2 is present or not is checked (#225), and, if the signal S2 is absent, the flow returns to step #205.

If the release button 13 is pressed fully and the signal S2 is produced, an S2-on procedure, which includes operations from the exposure of the image sensor 20 to the generation of image data and its recording on the recording medium M performed by the blocks from the A/D converter 21 to the recording portion 29, is executed (#230), and then the flow returns to step #10. In the S2-on procedure executed in step #230, the operations from exposure to image data generation are controlled according to the image type that has been determined.

If, in step #205, any of the detected values has so varied as to shift from one range to another, then, for the fourth method, the permissible variation ranges are set for the color balance, subject brightness, and focal length (#235), and a no-change duration, which represents the period of time in which a change in the detected values remains within the corresponding permissible variation range, is reset to zero (#240).

Next, the no-change duration is counted (#245). The no-change duration is counted by starting the timer 47 in step #240 and reading its output. Then, whether the non-change duration is equal to or longer than a predetermined period of time or not is checked (#250), and, if it is equal to or longer than the predetermined period of time, the flow returns to step #15. If the no-change duration is shorter than the predetermined period of time, then whether any of the detected values of the color balance, subject brightness, and focal length has changed out of the range in which it was in step #55 into another range or not is checked (#255), and, if no such change is observed, the flow proceeds to step #210. If any of the detected values has changed out of its original range, then whether the changes that have occurred in the detected values after step #205 are equal to or smaller than the permissible variation ranges set in step #235 or not is checked (#260). If any of the detected values has changed out of its permissible variation range, the flow returns to step #235; if all the detected values have remained in their permissible variation ranges, the flow returns to step #245.

In this flow of operation, when automatic focusing is performed for the first time (#45), the image type is determined (#55), and thereafter, when a change occurs in the detected values of the color balance, focal length, and the like, the image type is re-determined (#55). Here, in response to a change in the detected values, the image type is re-determined, by the second method, when the change involves shifting from one range to another (#205, #255) and in addition, by the fourth method, when the detected values have become stable (#250, #260). Here also, automatic focusing is performed as continuous AF. It is, however, also possible to inhibit automatic focusing once the subject is in focus by modifying the flow so that it returns from step #250 not to #15 but to #55.

The types of image discriminated, the shooting conditions used to discriminate them, any specific values given in connection therewith, and other specifics given in this embodiment are mere examples, and may therefore be defined and set in any other manner. The more finely images are classified into different types, the more frequently the image type is re-determined according to changes in the shooting conditions. Thus, classifying images into different types more finely helps enhance the usefulness of re-determining the image type according to changes in the shooting conditions.

Now, other embodiments of the invention will be described. The digital cameras of the embodiments described below differ from the digital camera 1 of the first embodiment described above only in the control they exercise to discriminate different types of image, and are similar to the digital camera 1 in their structure and in how they classify different types of images. Therefore, overlapping explanations will be omitted, and only differences will be described.

FIG. 12 schematically shows a rear view of the digital camera 2 of a second embodiment of the invention. The digital camera 2 is provided with, in addition to all the components constituting the digital camera 1, an operation key 18d, and thus the group of operation keys 31 shown in FIG. 3 includes this operation key 18d.

In the digital camera 2, the automatic discrimination mode, in which the image type is determined automatically, is further divided into a discrimination-lock mode, in which the image type is determined only when the taking lens is focused on the subject and is not re-determined thereafter even when a change occurs in the shooting conditions, and a continuous discrimination mode, in which the image type is determined when the taking lens is focused on the subject and is re-determined repeatedly thereafter. The discrimination-lock mode and the continuous discrimination mode are switched by operation of the operation key 18d.

By switching these modes, the user can choose to perform shooting with control exercised either according to the image type determined when the taking lens 10 is focused on the subject or according to the most recently determined image type.

Incidentally, the condition change detection portion 46 shown in FIG. 3 gives an instruction requesting image type discrimination when even a slight change occurs in the values detected by the detection portions 41 to 43 and the change persists, from when it started appearing, for a predetermined period of time. That is, the first and third methods described earlier are combined. The predetermined period of time is about 0.5 to 2 seconds.

The discrimination-lock mode is suitable, for example, when the user wants to shoot a landscape as a portrait. In this case, the user first performs zooming, i.e., makes the focal length of the taking lens 10 longer, so that the image type discrimination portion 45 determines the image type as a “portrait,” and then makes the focal length of the taking lens 10 shorter and performs shooting. The discrimination-lock mode is suitable also when the user wants to shoot a night scene but a bright light source in it makes it impossible to determine the image type as a “night scene.” In this case, the user first points the digital camera 2 in such a direction as to move the bright light source out of the shooting area so that the image type discrimination portion 45 determines the image type as a “night scene,” and then points the digital camera 2 back in the original direction and performs shooting.

On the other hand, the continuous discrimination mode is useful to obtain images rendered appropriately according to what appears in them in almost all situations other than such special cases as described above. For example, when the user wants to shoot a landscape with the focal length of the taking lens 10 kept long so that the focus is placed accurately on a single point, the image type discrimination portion 45 determines the image type as a “portrait,” but, when the user thereafter makes the focal length of the taking lens 10 shorter, the image type is re-determined as a “landscape,” making it possible to obtain the desired image.

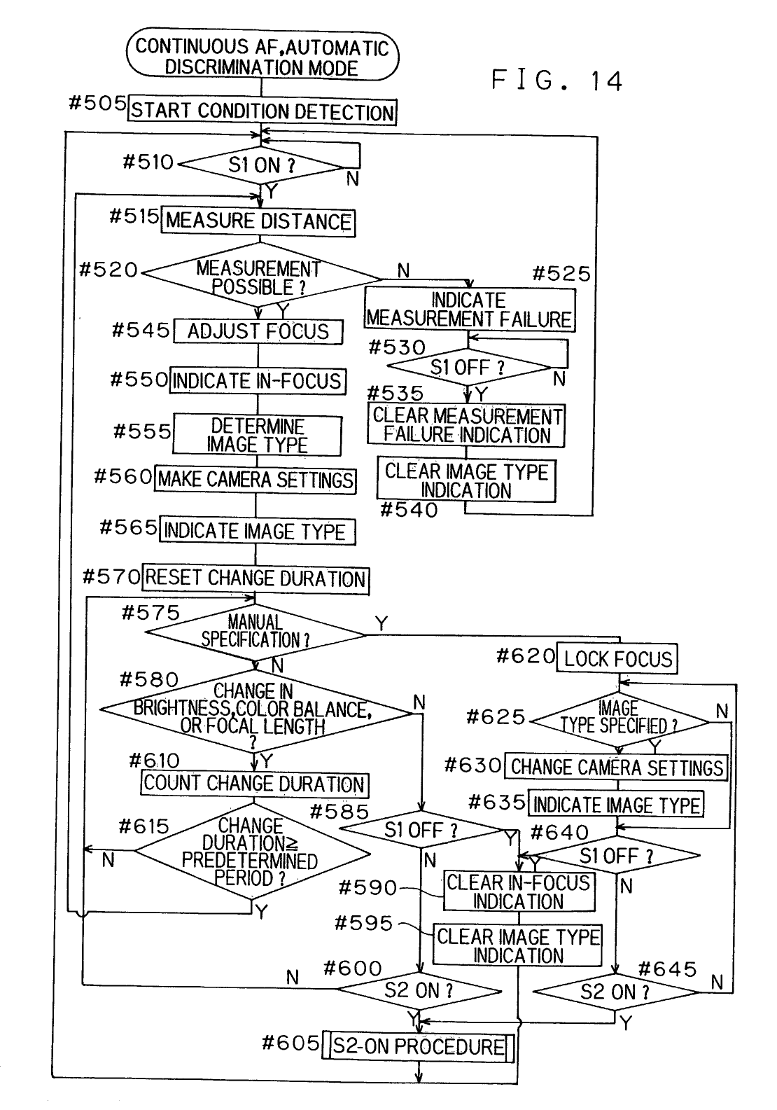

Now, the flow of operation performed to determine the image type in the digital camera 2 will be described with reference to a flow chart of FIG. 13. When the automatic discrimination mode is established, first, the shooting conditions (the color balance (R/G and B/G), subject brightness, and focal length) start being detected by the color balance detection portion 41, brightness detection portion 42, and focal length detection portion 43 (step #305). Next, whether the signal S1 is present or not is checked, and, if the signal S1 is absent, a wait lasts until the release button 13 is pressed halfway and the signal S1 is produced (#310).

If the signal S1 is present, the distance to the subject is measured (i.e., the amount of defocus is detected) by phase difference detection (#315), and then whether it is possible to perform the measurement or not is checked (#320). If it is impossible to perform the measurement because of low contrast, a message to that effect is displayed on the liquid crystal panel 17 and the viewfinder indication portion 33 (#325), and then a wait lasts until the signal S1 disappears (#330). When the release button 13 is let loose and the signal S1 disappears, the message indicating the failure of the measurement is cleared (#335), the indication of the image type is also cleared (#340), and then the flow returns to step #310. It is to be noted that the shooting of the image and the display of the live view is started before the automatic discrimination mode is established, and that the live view keeps being displayed throughout.

If it is possible to perform the measurement of the subject distance, the focus of the taking lens 10 is adjusted to the subject (#345), and, when the subject is in focus, a message to that effect is displayed on the liquid crystal panel 17 and the viewfinder indication portion 33 (#350). In addition, the adjustment of the focus by the lens driving/detecting portion 32 is inhibited so that the focus is locked (#355). The focus is thereafter kept locked until it is adjusted again when the flow returns to step #345 next time.

Next, which of the continuous discrimination mode and the discrimination-lock mode has been chosen by operation of the operation key 18d is checked (#360). If the continuous discrimination mode is chosen, the image type discrimination portion 45 performs calculation for image type discrimination (#365), and the determined image type is displayed on the liquid crystal panel 17 and the viewfinder indication portion 33 (#370). Then, the change duration, which represents the period of time that has elapsed after a change occurred in the detected values, is reset to zero (#375), and then whether there is any change nor not in the values of the color balance, subject brightness, and focal length detected by the color balance detection portion 41, brightness detection portion 42, and focal length detection portion 43 is checked (#380).

If, in step #380, no change is observed in any of the detected values, then whether the signal S1 is present or not is checked (#385). If the signal S1 is absent, the message indicating that the subject is in focus is cleared (#390), the indication of the image type is also cleared (#395), and the flow returns to step #310. If the signal S1 is present, then whether the signal S2 is present or not is checked (#400), and, if the signal S2 is absent, the flow returns to step #375.

If the release button 13 is pressed fully and the signal S2 is produced, the S2-on procedure, which includes operations from the exposure of the image sensor 20 to the generation of image data and its recording on the recording medium M performed by the blocks from the A/D converter 21 to the recording portion 29, is executed (#405), and then the flow returns to step #310. In the S2-on procedure executed in step #405, the operations from exposure to image data generation are controlled according to the image type determined in step #365.

If, in step #380, a change is observed in any of the detected values, the change duration is counted (#410). The change duration is counted by starting the timer 47 in step #375 and reading its output. Next, whether the change duration is equal to or longer than a predetermined period of time or not is checked (#415). If it is shorter than the predetermined period of time, the flow returns to step #380; if it is equal to or longer than the predetermined period of time, the flow returns to step #315.

If, in step #360, the continuous discrimination mode is not chosen, i.e., the discrimination-lock mode is chosen, the image type discrimination portion 45 performs calculation for image type discrimination (#420), and the determined image type is displayed on the liquid crystal panel 17 and the viewfinder indication portion 33 (#425). This indication is kept unchanged even when a change occurs in the shooting conditions (#430).

Next, whether the signal S1 is present or not is checked (#435). If the signal S1 is absent, the message indicating that the subject is in focus is cleared (#390), the indication of the image type is also cleared (#395), and the flow returns to step #310. If the signal S1 is present, then whether the signal S2 is present or not is checked (#440), and, if the signal S2 is absent, the flow returns to step #435.

If the release button 13 is pressed fully and the signal S2 is produced, the S2-on procedure, which includes operations from the exposure of the image sensor 20 to the generation of image data and its recording on the recording medium M performed by the blocks from the A/D converter 21 to the recording portion 29, is executed (#405), and then the flow returns to step #310. In the S2-on procedure executed in step #405, the operations from exposure to image data generation are controlled according to the image type determined in step #420.

In the continuous discrimination mode, when automatic focusing is performed for the first time (#345), the image type is determined (#365), and thereafter, when a change occurs in the detected values of the color balance, focal length, and the like, the image type is re-determined (#365). Here, in response to a change in the detected values, the image type is re-determined only when the change persists for the predetermined period of time (#415). Moreover, when a change occurs in the detected values and the image type is re-determined, automatic focusing is also performed (#345). Thus, automatic focusing is performed here as continuous AF. It is, however, also possible to inhibit automatic focusing once the subject is in focus by modifying the flow so that it returns from step #415 not to #315 but to #365.

In the discrimination-lock mode, when automatic focusing is performed for the first time (#345), the image type is determined (#420), and thereafter, the image type is not re-determined (#420), even when a change occurs in the detected values of the color balance, focal length, and the like, until the signal S1 disappears (#435) or the signal S2 appears (#440), that is, the indication (#425) of the image type determined first is maintained. Moreover, the focus is kept locked (#355), and thus focusing is performed here as focus-lock AF.

The more finely images are classified into different types, the more frequently the image type is re-determined according to changes in the shooting conditions. Thus, classifying images into different types more finely helps enhance the usefulness of the continuous discrimination mode in which the image type is re-determined according to changes in the shooting conditions, and also the usefulness of the discrimination-lock mode in which the image type determined first is maintained.

Next, the digital camera 3 of a third embodiment of the invention will be described. The digital camera 3 has the same appearance (FIGS. 1 and 2) and internal construction (FIG. 3) as the digital camera 1 of the first embodiment.

In the digital camera 3, automatic focusing can be performed either in a focus-lock AF mode, in which the focus stops being adjusted when the taking lens is focused on the subject, and a continuous AF mode, in which the focus continues being adjusted even after the taking lens is focused on the subject. These modes are switched by operation of the operation key 16a.

Either of the automatic discrimination mode and the manual specification mode, which relate to discrimination among different types of image, can be freely combined with either of the focus-lock AF mode and the continuous AF mode, which relate to automatic focusing. Thus, in the continuous AF mode, either of the automatic discrimination mode and the manual specification mode can be chosen. In the continuous AF, automatic discrimination mode, even after the image type is determined when the taking lens 10 is focused on the subject, the image type can be re-determined according to the movement of the subject, which is one of the shooting conditions. This makes it possible to obtain a meaningful discrimination result without fail.

As will be described later, the user is permitted to specify the image type temporarily in the middle of the automatic discrimination mode. Moreover, as in the digital camera 2 of the second embodiment, the condition change detection portion 46 gives an instruction requesting image type discrimination when even a slight change occurs in the values detected by the detection portions 41 to 43 and the change persists, from when it started appearing, for a predetermined period of time (about 0.5 to 2).

The combination of the continuous AF mode and the automatic discrimination mode will be described. In the digital camera 3, even when the automatic discrimination mode is chosen, the user is permitted to specify the image type. When the user specifies the image type in the automatic discrimination mode, the determination of the image type by the digital camera 3 itself is suspended; thus, shooting is performed and image data is recorded with control exercised according to the specified image type, and thereafter the determination of the image type is resumed.

In the middle of the automatic discrimination mode, the user can specify the image type, as when switching to the manual specification mode, by operating the operation keys 18a to 18c. Specifically, when the operation key 18a is operated with the signal S1 present, i.e., with the release button 13 pressed halfway, the digital camera 3 is brought into a state in which it accepts the specification of the image type in the middle of the automatic discrimination mode. When the operation key 18a is operated with the signal S1 absent, the automatic discrimination mode is switched to the manual specification mode.

When the operation key 18a is operated to specify the image type in the middle of the automatic discrimination mode, even if the continuous AF mode is chosen, the adjustment of the focus of the taking lens 10 is suspended so that the focus condition at that moment is maintained. That is, the focus is locked. The focus is thereafter kept locked until the signal S2 requesting the recording of image data is produced or the signal S1 disappears. Thus, the user can lock the focus at any time, specify the image type by operating the operation keys 18b and 18c in that state, and then shoot an image to be recorded. If the operation key 18a is operated again without the operation key 18b or 18c being operated, control is exercised according to the image type determined previously.

Now, the flow of operation performed to determine and specify the image type in the continuous AF, automatic discrimination mode will be described with reference to a flow chart in FIG. 14. First, the shooting conditions (the color balance (R/G and B/G), subject brightness, and focal length) start being detected by the color balance detection portion 41, brightness detection portion 42, and focal length detection portion 43 (step #505). Next, whether the signal S1 is present or not is checked, and, if the signal S1 is absent, a wait lasts until the release button 13 is pressed halfway and the signal S1 is produced (#510).

If the signal S1 is present, the distance to the subject is measured (i.e., the amount of defocus is detected) by phase difference detection (#515), and then whether it is possible to perform the measurement or not is checked (#520). If it is impossible to perform the measurement because of low contrast, a message to that effect is displayed on the liquid crystal panel 17 and the viewfinder indication portion 33 (#525), and then a wait lasts until the signal S1 disappears (#530). When the release button 13 is let loose and the signal S1 disappears, the message indicating the failure of the measurement is cleared (#535), the indication of the image type is also cleared (#540), and then the flow returns to step #510. It is to be noted that the shooting of the image and the display of the live view is started before the automatic discrimination mode is established, and that the live view keeps being displayed throughout.

If it is possible to perform the measurement of the subject distance, the focus of the taking lens 10 is adjusted to the subject (#545), and, when the subject is in focus, a message to that effect is displayed on the liquid crystal panel 17 and the viewfinder indication portion 33 (#550). The image type discrimination portion 45 then performs calculation for image type discrimination (#555), sets the relevant blocks so that exposure and other operations are controlled according to the determined image type (#560), and the determined image type is displayed on the liquid crystal panel 17 and the viewfinder indication portion 33 (#565).

Next, the change duration, which represents the period of time that has elapsed after a change occurred in the detected values, is reset to zero (#570), and then whether the operation key 18a is operated to start the specification of the image type or not is checked (#575). If the operation key 18a is not operated, whether there is any change or not in the values of the color balance, subject brightness, and focal length detected by the color balance detection portion 41, brightness detection portion 42, and focal length detection portion 43 after step #555 is checked (#580). If no change is observed in any of the detected values, then whether the signal S1 is present or not is checked (#585). If the signal S1 has disappeared, the message indicating that the subject is in focus is cleared (#590), the indication of the image type is also cleared (#595), and the flow returns to step #510.

If the signal S1 is present, then whether the signal S2 is present or not is checked (#600), and, if the signal S2 is absent, the flow returns to step #575. If the release button 13 is pressed fully and the signal S2 is produced, the S2-on procedure, which includes operations from the exposure of the image sensor 20 to the generation of image data and its recording on the recording medium M performed by the blocks from the A/D converter 21 to the recording portion 29, is executed (#605), and then the flow returns to step #510.

If, in step #580, a change is observed in any of the detected values, the change duration is counted (#610). The change duration is counted by starting the timer 47 in step #570 and reading its output. Next, whether the change duration is equal to or longer than a predetermined period of time or not is checked (#615). If it is shorter than the predetermined period of time, the flow returns to step #575; if it is equal to or longer than the predetermined period of time, the flow returns to step #515.

If, in step #575, the operation key 18a is operated, then the adjustment of the focus of the taking lens 10 by the lens driving/detecting portion 32 is inhibited so that the focus is locked (#620), and whether or not the image type is specified by operation of the operation key 18b or 18c is checked (#625). If the image type is specified by operation of the operation key 18b or 18c, the settings in the relevant blocks are changed so that exposure and other operations are controlled according to the specified image type (#630), and the specified image type is displayed on the liquid crystal panel 17 and the viewfinder indication portion 33 (#635).

Next, whether the signal S1 is present or not is checked (#640). If the signal S1 has disappeared, the message indicating that the subject is in focus is cleared (#590), the indication of the image type is also cleared (#595), and the flow returns to step #510. If the signal S1 is present, then whether the signal S2 is present or not is checked (#645), and, if the signal S2 is absent, the flow returns to step #625. If the signal S2 is present, the S2-on procedure, which includes operations from the exposure of the image sensor 20 to the generation of image data and its recording on the recording medium M performed by the blocks from the A/ID converter 21 to the recording portion 29, is executed (#605), and then the flow returns to step #510.

In this flow of operation, when automatic focusing is performed for the first time (#545), the image type is determined (#555), and thereafter, when a change occurs in the detected values of the color balance, focal length, and the like (#580), the image type is re-determined (#555). Moreover, when a change occurs in the detected values and the image type is re-determined, automatic focusing is also performed (#545). Thus, continuous AF is achieved.

After automatic focusing is performed for the first time (#545), when the operation key 18a is operated to specify the image type, the focus is locked (#620), and the user is permitted to specify the image type (#625) in that state. When the image type is specified, the control to be exercised is changed (#630) accordingly; when the image type is not specified, the control (#560) for the image type determined previously (#555) is maintained. In either case, the focus is locked until the signal S 1 disappears or the signal S2 requesting the recording of image data is produced (#640, #645), and is unlocked when the flow returns to step #5 10.

It is also possible to unlock the focus, i.e., resume continuous AF, when, after the operation key 18a is operated, the operation key 18a is operated again without any specification of the image type (i.e., without operation of the operation key 18b or 18). Even in that case, by re-determining the image type, it is possible to obtain an appropriate image according to the image type. To achieve this, the flow is, for example, so modified that, when no image type is specified in step #625, it proceeds not to step #640 but to step #510.

It is also possible to resume continuous AF when, after the image type was specified, a predetermined period of time has elapsed without the signal S2 produced. This is because a lapse of a long period of time after the specification of the image type may signify that the subject has moved so much that it is no longer appropriate to maintain the focus. To achieve such control, the flow is so modified that it includes, between steps #640 and #645, a step for comparing the period of time that has elapsed after the operation key 18a was operated in step #575 with a predetermined period of time and that, when the elapsed time exceeds the predetermined period of time, it returns to step #510.

In this embodiment, the types of image that the digital camera 3 discriminates are identical with those which the user can specify. However, it is also possible to permit the user to select among a larger number of types of image than the digital camera 3 can discriminate. By increasing the number of types of image that the user can specify, and classifying modes of control more finely so as to correspond to them, it is possible to cope more flexibly with the user's varying intentions. To enhance the significance of increasing the number of types of image that can be specified, it is necessary to perform shooting while maintaining the focus condition at the time of the specification of the image type by the user. This can be achieved without fail by suspending continuous AF when the user specifies the image type.

Obviously, many modifications and variations of the present invention are possible in light of the above teachings. It is therefore to be understood that within the scope of the appended claims, the invention may be practiced other than as specifically described.

What is claimed is:

1. An image taking apparatus in which a plurality of different types of image are previously defined to correspond to different shooting conditions so that a type of an image to be taken is determined according to a shooting condition under which the image is going to be taken, the image taking apparatus comprising:
a detecting element for detecting the shooting condition;
a discriminating element for determining the type of the image according to the shooting condition detected by the detecting element; and
a discrimination controlling element for detecting, after the discriminating element has determined the type of the image, a change in the shooting condition detected by the detecting element in order to make the discriminating element determine the type of image again.

2. An image taking apparatus as claimed in claim 1,
wherein the discrimination controlling element makes the discriminating element determine the type of the image again when the shooting condition changes out of a predetermined range.

3. An image taking apparatus as claimed in claim 1,
wherein the discrimination controlling element makes the discriminating element determine the type of the image again when a change in the shooting condition persists longer than a predetermined period of time.

4. An image taking apparatus as claimed in claim 1,
wherein the discrimination controlling element makes the discriminating element determine the type of the image again when the change in the shooting condition remains within a predetermined range for a predetermined period of time.

5. An image taking apparatus as claimed in claim 1, further comprising:
an indicating element for displaying information indicating the type of the image determined by the discriminating element.

6. An image taking apparatus as claimed in claim 1, further comprising:
a shooting controlling element for controlling operation performed when the image is taken according to the type of the image determined by the discriminating element.

7. An image taking apparatus as claimed in claim 6,
wherein the shooting controlling element controls at least one of exposure adjustment, flashing, gamma correction, sharpness adjustment, and color correction

8. An image taking apparatus as claimed in claim 1,
wherein the shooting condition detected by the detecting element is at least one of shooting magnification, taking lens focal length, subject movement, subject brightness, and color balance.

9. An image taking apparatus in which a plurality of different types of image are previously defined to correspond to different shooting conditions so that a type of an image to be taken is determined according to a shooting condition under which the image is going to be taken, the image taking apparatus comprising:
a detecting element for detecting the shooting condition;
a discriminating element for determining the type of the image according to the shooting condition detected by the detecting element;
a triggering element for instructing the discriminating element to determine the type of the image; and
a discrimination controlling element for switching states of the discriminating element between a state in which the discriminating element determines the type of the image only once in response to an instruction from the triggering element and a state in which the discriminating element determines the type of the image repeatedly in response to an instruction from the triggering element.

10. An image taking apparatus as claimed in claim 9, further comprising:
an indicating element for displaying information indicating the type of the image determined by the discriminating element.

11. An image taking apparatus as claimed in claim 10,
wherein, every time the type of the image determined by the discriminating element changes, the indicating element displays information indicating the type of the image anew.

12. An image taking apparatus as claimed in claim 9, further comprising:
a shooting controlling element for controlling operation performed when the image is taken according to the type of the image determined by the discriminating element.

13. An image taking apparatus as claimed in claim 12,
wherein the shooting controlling element controls at least one of exposure adjustment, flashing, gamma correction, sharpness adjustment, and color correction

14. An image taking apparatus as claimed in claim 9,
wherein the shooting condition detected by the detecting element is at least one of shooting magnification, taking lens focal length, subject movement, subject brightness, and color balance.

15. An image taking apparatus that automatically focuses a taking lens on a subject and in which a plurality of different types of image are previously defined to correspond to different shooting conditions so that a type of an image to be taken is determined according to a shooting condition under which the image is going to be taken, the image taking apparatus comprising:
an adjusting element for adjusting focus of the taking lens to the subject;
a detecting element for detecting the shooting condition;
a discriminating element for determining the type of the image according to the shooting condition detected by the detecting element;
a triggering element for making the adjusting element start adjusting the focus of the taking lens and for instructing the discriminating element to determine the type of the image;
an operation element operated by a user to specify the type of the image; and
an adjustment controlling element for making the adjusting element continue adjusting the focus of the taking lens even after the taking lens has been focused on the subject and for stopping the adjusting element from adjusting the focus of the taking lens when the operation element is operated.

16. An image taking apparatus as claimed in claim 15, further comprising:
a discrimination controlling element for detecting, after the discriminating element has determined the type of the image, a change in the shooting condition detected by the detecting element in order to make the discriminating element determine the type of image again.

17. An image taking apparatus as claimed in claim 15, further comprising:
an indicating element for displaying information indicating the type of the image determined by the discriminating element and for indicating, when the type of the image is specified by the user, information indicating the type of the image specified.

18. An image taking apparatus as claimed in claim 15, further comprising:
a shooting controlling element for controlling operation performed when the image is taken according to, when the type of the image is specified by the user, the type of the image specified and, when the type of the image is not specified by the user, the type of the image determined by the discriminating element.

19. An image taking apparatus as claimed in claim 18,
wherein the shooting controlling element controls at least one of exposure adjustment, flashing, gamma correction, sharpness adjustment, and color correction

20. An image taking apparatus as claimed in claim 15,
wherein the shooting condition detected by the detecting element is at least one of shooting magnification, taking lens focal length, subject movement, subject brightness, and color balance.

21. An image taking apparatus comprising:
an acquiring element for acquiring shooting information;
a discriminating element for determining a type of an image to be taken according to the shooting information;
a focusing element for performing focusing on a subject;
a focusing controlling element for continuously operating the focusing element;
an overriding element for manually overriding the determined type of the image; and
an inhibiting element for inhibiting operation of the focusing controlling element when the type of the image is overridden by the overriding element during continuous focusing operation in which the focusing element is continuously operated by the focusing controlling element.
